(19) United States
(12) Patent Application Publication
(10) Pub. No.: US 2021/0095521 A1
(43) Pub. Date: Apr. 1, 2021

(54) Less Visible Coated Fibers and Less Visible Screens

(71) Applicants: James McNeill, Tuscaloosa, AL (US); Ryan Beam, Tuscaloosa, AL (US)

(72) Inventors: James McNeill, Tuscaloosa, AL (US); Ryan Beam, Tuscaloosa, AL (US)

(21) Appl. No.: 16/987,177

(22) Filed: Aug. 6, 2020

Related U.S. Application Data
(60) Provisional application No. 62/883,923, filed on Aug. 7, 2019.

(51) Int. Cl. E06B 9/52; D03D 9/00; D01F 6/30

(52) U.S. Cl. CPC E06B 9/52; D03D 9/00; D10B 2331/04; D10B 2321/02; D01F 6/30

(57) ABSTRACT

The invention includes a meth of manufacturing an almost invisible coated monofilament, the coated monofilament, and a screen created using the almost invisible coated monofilaments. The method includes the step of selection a clear monofilament having a first perpendicular index of refraction, and selecting a clear elastomer coating having a second perpendicular index of refraction, where the two index of refraction are within 2% of one another. The monofilament is coated by extrusion coating using a tube die, where a vacuum is applied to the thread entrance or threadway of the extrusion system prior to coating.

### PRIORITY CLAIM

This application claims the priority benefit of U.S. provisional application 62/883,923 filed on Aug. 7, 2019, hereby incorporated by reference.

### FIELD OF THE INVENTION

The invention relates to yarns for screens such as, for example, for windows and doors that are less visible than conventional screens.

### BACKGROUND OF THE INVENTION

Screens are installed on windows and doors to promote ventilation while excluding insects, pollen and other air born nuisances. Screens are widely regarded as unattractive on homes. Screens can obstruct the view to the outside, while when viewing from the outside, screens appear to darken a window, detracting from the overall appearance of a home or building. Attempts have been made to lessen the impact of screen material on a window or door, including modifying the screen thread to be reduced in size, modifying the opening size in a screen material to reduce the opening size, and using gray screening material or other less intrusive colors. Efforts can be seen in U.S. Pat. No. 7,201,208, to Russell Pylkki incorporated by reference.

Despite the efforts in the industry, there is a need for screens and screen material that is substantially transparent.

### SUMMARY OF THE INVENTION

The invention induces a transparent monofilament fiber with a transparent extrusion coating, where the extrusion coating and the monofilament yarn have index of refraction, in the perpendicular direction, that closely match, such as by being within 1% of each other, or 0.5%, 0.2% of one another or 0.2% of each other.

The invention includes an extrusion coated monofilament where the extrusion coating is transparent and is selected for clarity.

The invention includes an extrusion coated monofilament where the monofilament is a nylon, PET, or a TPU.

The invention includes a method of coating a monofilament yarn

### DESCRIPTION OF THE FIGURES

FIG. 1 shows a photo micrograph of a clear coated 0.13 mm PET monofilament fiber coated with a cleat TPU coating with the view being across the length of the fibers.

FIG. 2 shows a photo micrograph of the coated PET fibers of FIG. 1, where the view is end on or down the fiber.

FIG. 3 is a cross section through a schematic representation of tube die.

### DETAILED DESCRIPTION OF THE INVENTION

Screens are constructed with yarns formed from twisted multifilament threads, typically fiber glass. The raw yarn material is then coated, such as with extrusion or liquid coating techniques, into a finished yarn used for weaving the screen mesh product. The specifications for the yarn thickness, strength, and even color will be dependent on the particular screen application.

To build an “invisible” or less visible screen, the first step is to use yarns that are clear or “invisible” as the starting material, where the chosen material is suitable as screen material. Many existing screen fiber materials are available as a clear monofilament thread, (or “monofilament” or “monofilament fiber”) such as nylon, olefin, thermoplastic polyurethanes (TPU), Acrylics and Polyesters (PETs). In the preferred embodiment, the base thread will be a single monofilament fiber. A typical product will have a monofilament diameter of about 0.055 mm to about 0.4 mm. For reference, 0.055 mm is 2.165 mil, where mil is a thousandth of an inch.

Once the monofilament material is selected, the next step is to choose a clear polymer coating material, where the selected polymer coating (including additives) has a refractive index that closely approximates the refractive index of the monofilament fiber. By choosing a clear coating with similar refraction index, the monofilament yarn will disappear in the coating, creating a single clear strand, with little or no internal refraction or reflection that would alter light transmission paths through the coated filament. Reflection and refraction will occur at the air/fiber interface, but internal effects can be minimized.

Typical refractive index (“RI”) for fibers are shown in Table 1, while typical clear polymer coatings RI are shown in Table 2.

TABLE 1
Refractive index of fibers

| Refractive Index | E glass | PET | Nylon | Olefin | TPU | Acrylic |
|---|---|---|---|---|---|---|
| Perpendicular | 1.55 | 1.54 | 1.52-1.54 | 1.51-1.53 | 152-1.56 | 1.49-1.57 |

TABLE 2
Refractive Index of classes of elastomeric polymer resin coatings
Refractive Index

| | Polystryene | TPU, | TPU, | Poly- | Polyamide | Poly- | Poly- |
|---|---|---|---|---|---|---|---|
| PVC | (SBC) | aliphatic | aromatic | ethylene | Nylon | Acrylics | Olefin |
| 1.531-1.55 | 1.55-1.59 | 1.486-1.499 | 1.526-1.568 | 1.51-1.54 | 1.53-1.54 | 1.49-1.57 | 1.51-1.53 |

Preferably, the selected polymer resin RI is within 1% of the monofilament RI; more preferred, within 0.5%; most preferred, within 0.20%.

Some monofilament samples may use a polymer without the need for plasticizers. Other fibers may be coated with other polymer compounds with plasticizers. The coated formulation can include polymer, resin, plasticizer and other desired additives, such as UV stabilizers. All additives preferably will be a clear substance in the polymer mixture, (unless a transparent colored product is desired). Preferably, the total coating RI should be within 2% of the monofilament RI, however additives will make up a minor portion by volume of the coating material and should not substantially alter the RI of the initial polymer

The selection of the coating polymer may be dependent on the coating method, the selected monofilament fiber, and the intended use for the fiber. Coating methods include, for instance, extrusion coating, drip or dip coatings, or vapor deposition coating.

Extrusion coating is a preferred method, as the finished thickness and shape of the coating can be more readily controlled (coating thickness of about 2 to 5 mil, or an increase in the diameter of the thread of 4-10 mil is preferred for each extrusion pass). There may be multiple coating passes, and the coating layers do not have to be the same material. Additionally, extrusion coating allows for control of the finished surface gloss with control of the die temperature during coating. An increase in die temperature, for example, will result in a yarn with higher gloss. For a finished coated monofilament shape, round coated fibers are typical. However, an oblong, flattened coated monofilament may be preferred as a base material for screens, as this shape allows for increased contact between crossing fibers in a woven screen finished product, thereby assisting in creating a single ray path between the two fibers for each incident ray, with refraction and reflection minimized in the overlapped contact area. The increased contact area may also reduce the amount of trapped air between the overlapped fibers when tentering, or stretching the woven screen into its final shape.

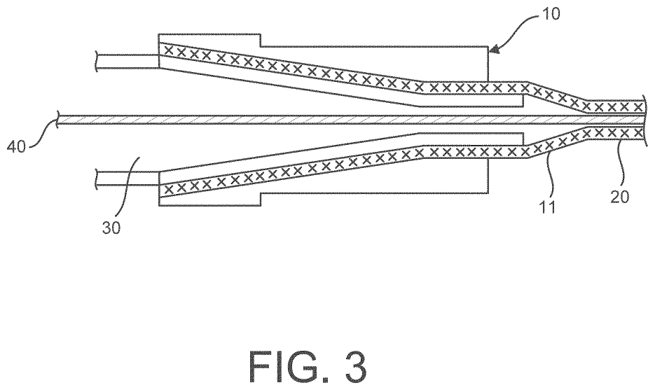

Air can become trapped between the coating and the monofilament during the coating process, creating bubbles in the finished product where reflection and refraction will occur. This is an undesirable result. This is one reason why a twisted multithread yarn is not preferred, as air likely will be trapped between the twisted fibers during coating. To reduce trapped air, the resin can contain an additive to reduce air entrapment (for dip or drip coatings). In a preferred extrusion method, the monofilament travels through the coating system and is coated as is passes through the die. After coating the coated filament is cooled, such as in a water bath or water spray system, to cool the molten polymer and avoid sags in the coating. Prior to cooling, the coated thread may be passed through a mandrel for shaping, such as to produce an oblong shape coating. (the shaping will normally be a process of the die). In an extrusion coating system, elastomeric polymer resin pellets are usually supplied as p through a hopper to a heated chamber in which a screw turn. Some resins, such as TPU resins, the resin may need to be dried to remove moisture. The screw feeds and shears the resin through the chamber where it is melted. and delivers the melted polymer to the die for coating the monofilament which is traveling through the die. For coating a monofilament, 40 a tube die 10, is preferred, an example of which is shown in FIG. 3, instead of a pressure die, to reduce shearing of the traveling filament by high pressures and additionally to apply a vacuum to the traveling thread 40 prior to coating as later described. In tube die extrusion, a vacuum may be applied before the extrusion point of the die. such as in the threadway 30 to the die 10. The threadway is a small bored tube in the die stem in which the thread is fed into the die.

The applied vacuum is used to extract air adhering to the fiber and in the chamber prior to extrusion, and to extract air in the chamber prior to extrusion, thereby reducing trapped air between the yarn and the coating, and eliminating air bubbles in the coated monofilament. The length of the pathway to the die is set to provide sufficient time for the chamber and the traveling thread to be exposed to the applied vacuum. In general, suitable coating systems are standard coating systems, well known in the art. The speed of the traveling thread, the temperature of the molten polymer, the vacuum strength and operating speed of the feed screw are all parameters that can be modified in extrusion systems to ensure complete coverage and adequate bonding of the coating to the filament. By employing clear monofilament yarns and clear polymer coatings, with closely matched RI, the completed coated yarn product will have high light transmittance and little internal reflections. When the completed fiber has almost no gloss (e.g., a “flat” clear sheen) on the outer coating (e.g. low specular reflectivity coating), transmittance through the fiber is maximized, resulting in an almost invisible fiber. Some loss may be had by non-specular reflection (scattering) on the surface of the coating, but such reflection has little impact on visualization through the coated filament. With such a coated fiber, screens can be produced in the desired screen mesh, by weaving the screens with a coated monofilament in both the warp and the weft, and result in a less visible screen.

### EXAMPLES

Examples using a PET (polyethylene terephthalate) or Nylon monofilament core yarn with a PVC (polyvinyl chloride) or TPU coating were tested to achieve the matched refractive index.

Spools of PET and nylon monofilament ranging from 0.13-0.25 mm thickness were tested, with the following RI:

Refractive Index

| | PET | Nylon |
|---|---|---|
| Parallel | 1.72 | 1.38 |
| Perpendicular | 1.54 | 1.52 |

Typical monofilament thread suitable for screens will be in the range of 0.055-0.4 mm.
   Threads for other applications can be different thicknesses.

Two PVC compounds were formulated by a third-party formulator to closely match the refractive index of PET and Nylon. Similarly, four TPU (thermoplastic Polyurethane) compounds were formulated by a third-party formulator to closely match the RI of PET and Nylon. The specification of the desired polymer characteristics are generally supplied to a third-party formulator, who will provide different formulations to trial. There may be some experimentation with formulations and process parameters to reach a desired result. For drip or dip coating, the formulator will add the requested additives into the liquid resin compound and consisting of the resin, and other ingredients. In extrusion, coating, the polymer resin is generally supplied as a solid pelleted This is referring to a plastisol again, so it is a compound and not just a resin.

usually supplied as a solid pellet, and the additives can be added into the hopper feed with the pelleted resin. The PET monofilament was coated using the two PVC and four TPU compounds, separately, in an extrusion process, on a single-end head, utilizing a tube die setup with an applied vacuum near the starting end of the entryway to the die.

The applied vacuum is applied prior to the extrusion of the melted polymer onto the traveling fiber. The vacuum helps pull air out of the chamber, avoid air in the chamber being trapped between the yarn and the coating, or to remove air adhering to the fiber, to eliminate internal bubbles in the coated fiber. In one embodiment, the vacuum was applied at the beginning of the thread entrance way into the extrusion head die. Within the thread entry, a tube is bored that extends into the thread passageway before the extrusion point in the die, in which a vacuum can be applied, such as by a vacuum pump.

In other embodiments, the vacuum may be applied in the die, but this is not preferred. The die applied vacuums are in the range of 0.04 MPa to 0.08 MPa.

The vacuum applied in the present case was 0.06 MPa. Process temperatures were maintained at 300-450 F for all extruder zones depending on the polymer coating, and yam speeds ranged from 500-1000 feet per minute. The water bath was held at ambient temp (75 F) throughout the run. This same procedure was repeated using Nylon as the monofilament core yarn.

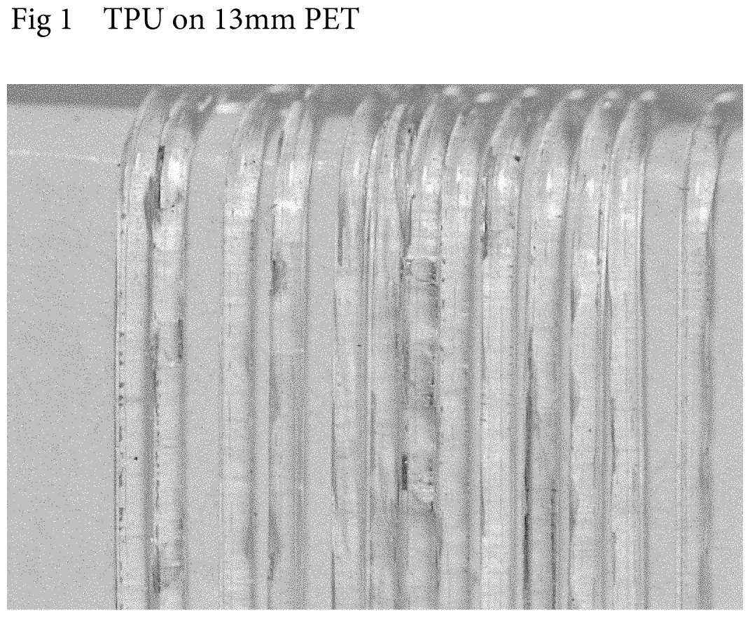

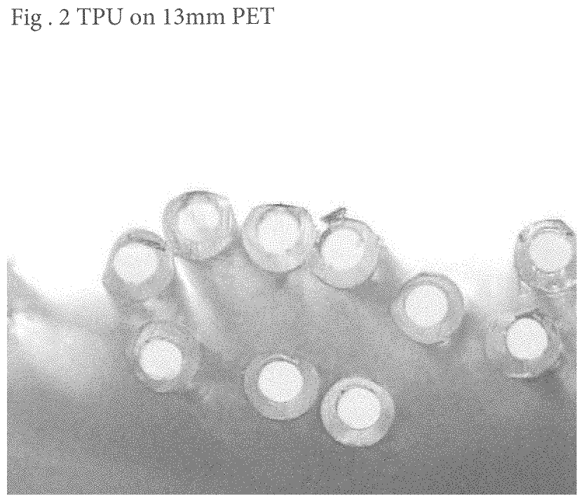

Adhesion to both monofilaments was sufficient with all resins and filaments. With the PET monofilament trial, we were able to make a coated yam where the refractive index of both the monofilament and coating match (less than 1.0% difference) in the perpendicular direction. The coating thickness of the resin or the applied extrusion coating was between 2 mil and 3 mil. Even when observed under a microscope, the core yarn was difficult to observe. See FIG. 1, with magnification of 25×. The monofilament core is only visible by looking at a cross section of the coated yarn. See FIG. 2. This is due to the core yarns PET and Nylon and the PVC and TPU coatings having a different refractive index in the parallel direction than the perpendicular direction. For most of the monofilaments listed in table 1, the refractive indexes are slightly different in the perpendicular and parallel direction. This is known as birefringence, the optical property of a material having a refractive index that depends on the polarization and propagation direction of light. However, for an insect screen and many other composite material embodiments, only the perpendicular refractive index will be a factor in a finished woven material. Similar results were obtained using all monofilaments and coatings, with some minor variation. The “best” combination, chosen by eye, was the TPU coated PET monofilament.

Clarity of amorphous solid, like glass, have high transparency because light passes more easily through the material. Crystalline solids, however, can scatter light and appear more opaque. Polymer manufactures are able to control how amorphous or crystalline their polymers are by use of additives and temperature settings. Hence, clarity and transparency in the yarn can be controlled by the polymer resin coating manufacturer, and a clear product with high clarity should be specified to the formulator.

The goal is to have a high clarity core yarn monofilament and elastomeric polymer coating that approaches that of glass so that light passes through with little internal scattering. We observed that in plaques of the PVC and TPU polymer compounds, as the thickness of the plaque increases, the clarity or transparency is reduced. The objective would be to select the optimum minimum coating thickness for visual properties while still allowing sufficient bonding and other physical properties desired in a coated yarn for the intended woven product. For a screen application, these characteristics would include tensile strength, UV resistance, abrasion resistance, bond strength of the coating, for instance. Many of these characteristics are imparted to the polymer by additives added into the formulation (for extrusion methods).

The method can also be used

with twisted multifilament monofilament yarns, but some trapped are likely will remain, and hence are not preferred yarns.

1. A fiber comprising a single clear monofilament fiber having a first perpendicular index of refraction, the fiber further comprising a clear elastomeric polymer coating covering the single clear monofilament fiber, the clear elastomeric polymer coating having a second perpendicular index of refraction, where the first perpendicular index of refraction and the second perpendicular index of refraction are within 2% of one another.

2. The fiber of claim 1 where the single clear monofilament fiber has a diameter in the range of 0.055 mils-0.4 mils.

3. The fiber of claim 2 where the single clear monofilament fiber comprises one of the following materials: e-glass, PET, Nylon, Olefin, TPU or acrylic.

4. The fiber of claim 1 where the clear elastomeric polymer coating has a thickness of 2-5 mil.

5. The fiber of claim 4 where the clear elastomeric polymer coating has an outer surface, and the outer surface has low specular reflection.

6. The fiber of claim 2 where the clear elastomeric polymer coating comprises material selected from table 2.

7. An insect screen material comprising a textile woven from fibers, where the fibers consist essentially of a single clear monofilament fiber having a first perpendicular index of refraction, and at least one clear elastomeric polymer coating covering the single clear monofilament fiber, where the single clear monofilament fiber has a first perpendicular index of refraction and the at least one clear elastomeric polymer coating has a second perpendicular index of refraction, where the first perpendicular index of refraction and the second perpendicular index of refraction are within 2% of one another.

8. A method of manufacturing a fiber comprising the steps of providing a single clear monofilament having a first perpendicular index of refraction, providing a clear elastomeric polymer comprising a clear elastomeric resin and additives, where the elastomeric resin has a second perpendicular index of refraction, where the first perpendicular index of refraction and the second perpendicular index of refraction on are within 2% of one another, passing the single clear monofilament through a tube die at a selected speed, melting the clear elastomeric polymer, extruding the melted clear elastomeric polymer into the tube die, applying a vacuum within an entranceway of a threadway of the tube die, whereby the melted clear elastomeric polymer coats the traveling single clear monofilament, and cooling the coated single clear monofilament.

9. The method of manufacturing of claim 8 where the die head is heated to a first temperature.

10. The method of manufacturing of claim 8 where the single clear monofilament travels through the die at a rate of speed between 500 ft/sec to 1000 ft/sec.

11. The method of claim 8 where the applied vacuum is in the range of 0.04 Mpa to 0.08 Mpa.
